(19) United States
(12) Patent Application Publication
(10) Pub. No.: US 2012/0218287 A1
(43) Pub. Date: Aug. 30, 2012

(54) Apparatus, system and method for electronic book reading with audio output capability

(76) Inventor: Thomas J. McWilliams, Bryn Mawr, PA (US)

(21) Appl. No.: 12/932,505

(22) Filed: Feb. 25, 2011

(51) Int. Cl. G09G 5/00; G06T 1/00

(52) U.S. Cl. 345/619; 345/418

(57) ABSTRACT

An electronic book reader, an electronic book reading system, and a method for executing electronic book reading. The reader, system and method may include a display, at least one microprocessor that visually executes ones of a plurality of book data to the display, at least one storage element that stores the plurality of book data, and a plurality of modes executable by the at least one microprocessor, wherein at least one of the plurality of modes comprises audibly executing at least one of the plurality of book data, such as to at least one Bluetooth output. The method may further include storing a plurality of electronic book data, visually outputting the electronic book data to a display, wherein a user scrolls through the book data on the display; and audibly outputting the electronic book data to a plurality of automobile speakers, such as via a Bluetooth interfacing simultaneously with the visually outputting.

### CROSS-REFERENCE TO RELATED APPLICATIONS

This application claims the benefit of priority to U.S. Provisional Patent Application Ser. No. 60/339,125, filed Feb. 26, 2010 by inventor Thomas J. McWilliams, and entitled “APPARATUS, SYSTEM AND METHOD FOR ELECTRONIC BOOK READING WITH AUDIO OUTPUT CAPABILITY,” the entire disclosure of which is incorporated herein by reference as if set forth in the entirety.

### BACKGROUND

1. Field of the Invention

The present invention relates to electronic book readers and tablet computer capable of electronic book presentation, and, more specifically, to a device, system and method of providing an electronic book reader having an audio output capability.

2. Background of the Invention

An electronic book reader is an electronic device that is designed primarily for allowing users to read digital books and periodicals. Current electronic book readers display content to readers, and are also referred to as e-book devices or e-readers. Such devicesd may be dedicated e-book readers, or may include tablet computers and/or smartphones, for example. Models of electronic book readers are numerous, and currently include, among others, models provided by Barnes and Noble, Apple, Sony, Amazon, and many others. E-readers typically provide portability, improved readability even in bright light, and long battery life. E-readers may present items to read in black and white, and other, particularly tablet ebook readers, may present items to read in color. Further, e-books may include not only books, but also magazines and the like, and may be interactive. Personal Digital Assistants (PDAs), such as most smartphones, are capable of use as portable e-book readers, but do not provide many of the advantages of true electronic book readers.

Numerous current eletronic book readers use electronic ink, or “e-ink.” E-Ink is a proprietary electronic paper. E-Ink is presently available only in grayscale. E-Ink is processed into a film for integration into electronic displays, which film allows for particularly low power consumption. E-Ink is currently in use in, among others, the Sony e-Reader, the Amazon Kindle, and the Barnes & Noble Nook.

However, current eletronic book readers make no allowance for circumstances in which the user cannot consistently view the electronic reader, and hence cannot read the book. Thus, the need exists for an apparatus, system and method of providing an electronic book reader having an audio output capability.

### SUMMARY OF THE INVENTION

The present invention provides an electronic book reader, an electronic book reading system, and a method for executing electronic book reading. The reader, system and method may include a display, at least one microprocessor that visually executes ones of a plurality of book data to the display, at least one storage element that stores the plurality of book data, and a plurality of modes executable by the at least one microprocessor, wherein at least one of the plurality of modes comprises audibly executing at least one of the plurality of book data, such as to at least one Bluetooth output. Such a Bluetooth output may be interfaced to automobile speakers, a Bluetooth earbud, or the like. In embodiments linking a tablet computer to a Bluetooth earbud, telephonic capabilities may be provided by the tablet computer through the earbud, and the tablet may additionally provide, for example, proximity or touch charging of the Bluetooth earbud from the tablet computer, such as via the back of the tablet.

The method may further include storing a plurality of electronic book data, visually outputting the electronic book data to a display, wherein a user scrolls through the book data on the display; and audibly outputting the electronic book data to a plurality of automobile speakers, such as via a Bluetooth interfacing. Such an audible output may be made simultaneously with a visual outputting. In other words, in embodiments of the present invention, the audible and visual outputting of a subject book may preferably be linked by the at least one microprocessor, such that the associated memory location for a then-reading location in a visual e-book may be directly corresponded to the same memory location in the corresponding audio e-book, and vice versa.

Therefore, the present invention provides an apparatus, system and method of providing an electronic book reader having an audio output capability.

### BRIEF DESCRIPTION OF THE FIGURES

Understanding of the disclosure will be facilitated by consideration of the following detailed description of the embodiments of the disclosure, taken in conjunction with the accompanying drawings, in which like numerals refer to like parts, and wherein:

FIG. 1 is a block diagram illustrating aspects of an electronic book reader having an audio playback; and

FIG. 2 is a flow diagram illustrating aspects of an exemplary method in accordance with the present invention.

### DETAILED DESCRIPTION OF THE INVENTION

It is to be understood that the figures and descriptions of the disclosure have been simplified to illustrate elements that are relevant for a clear understanding, while eliminating, for the purpose of brevity, many other elements found in typical electronic reader and electronic book delivery systems and methods. Those of ordinary skill in the art will thus recognize that other elements and/or steps are desirable and/or required in implementing the disclosure. However, because such elements and steps are well known in the art, a discussion of such elements and steps is not provided herein. The disclosure herein is directed to all such variations and modifications to such elements and methods known to those skilled in the art.

The discussion herein is directed to electronic book readers, or e-book readers, that provide books to readers electronically. As used herein, these terms refer to dedicated e-book readers, as well as tablet computers and the like. In certain embodiments, the inventors of the present disclosure appreciate that aspects of the present invention may also be applicable to smartphones, although smartphones may lack certain features that contribute to the desirability of e-book readers.

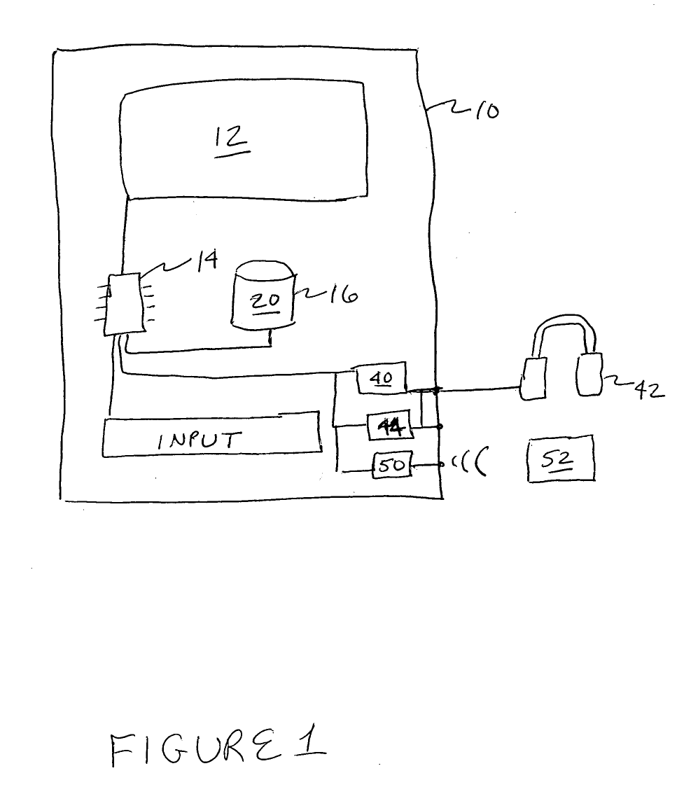

As illustrated with respect to FIG. 1, an electronic book reader 10 typically provides a screen 12, with models having screens that are easier to read, and/or that provide a color screen, and/or that provide additional computing features such as are provided by tablet computers, correspondingly having a typically increased price. The electronic book reader further includes at least one microprocessor 14 that allows for the conversion of book data 16 to output on the screen, and for manipulating 18 the output on the screen in accordance with the direction of the user.

The microprocessor performs this conversion via one or more rule sets 56 and other and additional software programs, such as applications, that may additionally provide the interface for the user discussed hereinthroughout As used herein, these software programs comprise computer readable instructions which, when executed by the microprocessor, cause to be performed the functions, steps, actions and devices discussed and provided herein.

The electronic book reader may additionally include at least one storage device 20 communicatively connected to the microprocessor, wherein the storage device may store one or more books, in data format, for conversion of the book data 16 by the microprocessor 14 to output on the display 12 for reading of the book correspondent to the book data by the user. The storage device may additionally store one or more aspects of the software, such as the application software, discussed hereinabove.

E-book readers allow for a user to obtain numerous books, and make those books mobile without having to carry the bulky physicality of books on the person of the user. As such, electronic book readers are very popular for frequent travelers, frequent vacationers, and the like. In such instances, a large number of books may be downloaded to the electronic book reader for ultimate reading by the user, wherein the downloaded books are thus mobile with the mobile user. Those skilled in the art will appreciate that there may be an attendant charge for each book downloaded to the electronic book reader of the user, or books, or portions of books, may be provided at no charge.

Current electronic book readers require visual reading by the user. Because frequent travelers and frequent vacationers are often unable to look at a viewing screen in order to read a book, such as wherein the frequent traveler is driving a car, or a frequent vacationer has to be watching children, the need for a user to use the visual sense in current electronic book readers is often inefficient, undesirable, or simply not possible.

The present invention provides an electronic book reader having multi-functionality reading, wherein a first functional mode 40 electronically reads a book to the user, such as through a wired output such as headphones 42, using an electronic voice, and wherein a second functional mode 44 may, such as by using sampled voices of, for example, celebrities, read a book to the user in a particular voice, such as through the headphones 42, and wherein a third modality 50 may, for example, provide a wireless output 50, such as a Bluetooth output or a speaker output to a speaker on the e-book reader. A Bluetooth output may be used for communicating with, for example, a Bluetooth earbud or a Bluetooth system in an automobile 52, whereby the output of the electronically read book, such as output in the first 40 or second 44 modality, may be sent to, for example, the earbud and/or the speakers in an automobile via the Bluetooth.

There may be a differentiation, or no differentiation, between book data for audio output versus visual output in the instant invention. For example, books may be downloaded for optional use in either format, or may be differentiated, such as by price, based on availability for audio output, visual output, or availability for both. Likewise, rather than fully downloading a book in a unitary multiformat, or several formats, a book may be at least partially streamed for reading (in which case the streamed portion may be stored in a cache memory, such as for temporary storage, for example). The download or streaming preferably allows for the tracking of the current reading location of the user within the book, as discussed further hereinbelow.

More specifically, the present invention may include, such as in association with the aforementioned microprocessor, one or more rule sets 56 for a non-visual output from the electronic book reader. Such rule sets may be in accordance with a rules engine, and a rules engines will be understood by those skilled in the art to include one or more software code sets which, when executed by a microprocessor, cause the microprocessor to output, such as to one or more output ports, particular information, or information in accordance with particular characteristics. The rule set 56 may, for example, indicate a switch from a visual reading to one of the aforementioned audio reading modalities in accordance with a hardware indication, such as by the user to the display or by the presence of Bluetooth or headphones as discussed hereinthroughout.

Thus, in accordance with the present invention, the microprocessor of the present electronic book reader may review one or more output ports when presenting a book. For example, if the electronic book reader inserts headphones into the headphone jack, the electronic book reader may, rather than merely outputting a book visually, output the book audibly through the headphone system. Further, in such an embodiment, the rules engine may cause the microprocessor to ask, either audibly or visually, what sort of audible output the user elects, such as whether the user elects to have one or more standard electronic voices execute the audible book reading, or whether the user wishes to have one or more celebrity approximation voices output the book reading.

Additionally and alternatively, the microprocessor may assess the presence, such as at one or more Bluetooth ports, of an available Bluetooth connection, such as in the manner currently performed by mobile communication devices, such as cellular telephones when placed in an automobile with Bluetooth. Upon sensing a Bluetooth connection, the microprocessor may cause to be executed, either automatically or at the option of the user, an audible output to the one or more Bluetooth outputs. Needless to say, the receiver of the output for output to the user, such as the Bluetooth system in an automobile or a Bluetooth earbud, may complete handshaking prior to outputting to the user. Thereby, for example, the electronic book may be audibly output to the speakers of a car, for example. Further, those skilled in the art will appreciate, in light of the discussion herein, that a Bluetooth output may also allow for election by the user, such as audibly or through the visual interface, of the manner of the Bluetooth output, such as the voice type or tone, or the speakers, or the volume, or the tone or balance, that will be used to provide the audible electronic book reading.

It will be appreciated by those skilled in the art in light of the discussion herein that other output types may allow for audible output from the electronic book reader to other output types, in addition to the exemplary types discussed hereinthroughout. For example, such output types may include audio-visual or audio RCA jacks, speaker or microphone output, such as for use with a personal computer, infrared output, or the like.

Thus, the present invention provides an electronic book reader, an electronic book reading system, and a method for executing electronic book reading that allows for a Bluetooth output to be interfaced to automobile speakers, a Bluetooth earbud, or the like. In embodiments linking a tablet computer to a Bluetooth earbud, those skilled in the art will appreciate that telephonic capabilities may be provided by the tablet computer through the earbud. The tablet may additionally provide, for example, proximity or touch charging of the Bluetooth earbud from the tablet computer, such as via the back of the tablet.

The apparatus, system and method as disclosed may include providing the plurality of electronic book data in an audible output simultaneously with, or discretely from, the visual outputting. In other words, in embodiments of the present invention, the audible and visual outputting of a subject book may be discretely provided, but may preferably be linked by the at least one microprocessor, such that the associated memory location for a then-reading location in a visual e-book may be directly corresponded to the same memory location in the corresponding audio e-book, and vice versa.

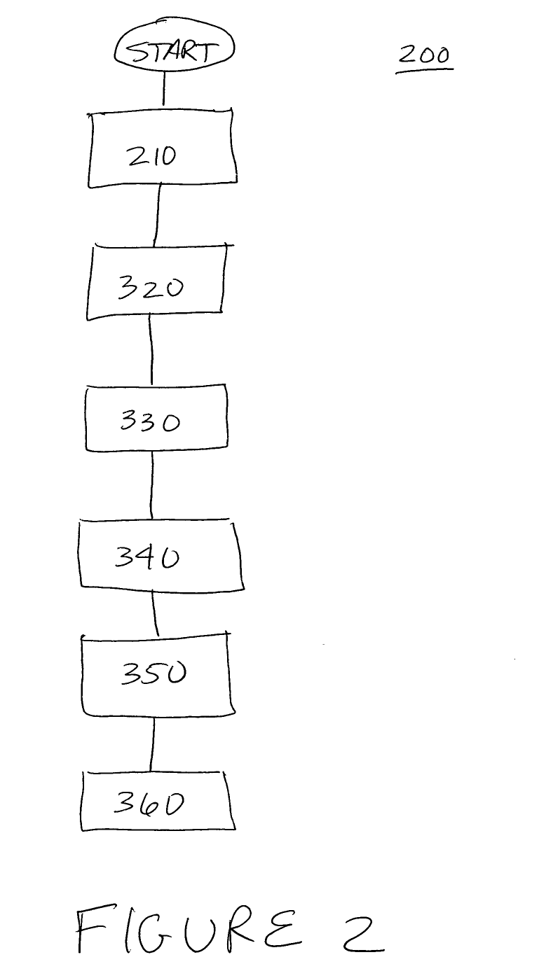

By way of non-limiting example, and with reference to the exemplary method illustrated in FIG. 2, a method 200 according to the present invention may include the step 210 of offering multiple data files, wherein at least one such file is a visual reading file, correspondent to a particular reading material, such as a book or magazine. Others of the data files may include, for example, one or more audio files of the same book or magazine as is resident in the correspondent visual reading file. Of course, those skilled in the art will appreciate that, although larger, both audio and visual reading data may be resident in a single file, although download speeds may be slowed in such embodiments. By way of example, a visual reading file may be available, and may be corresponded to audio files of the same book or magazine as the visual file, wherein the audio files may be, for example, different voices reading the same material. Alternatively, a single audio file may be employed, and the differences in audible presentation, i.e., the different reading voices that may read aloud the book or magazine, may be “thick client,” that is, may be resident in association with the microprocessor of the subject e-book reader.

Ones of the offered files may be downloaded to one or more users, pursuant to a user request and over at least one wireless network, such as a Wi-Fi or cellular (3G or 4G, for example) network, at step 320. It goes without saying that a charge may be incurred by a user downloading an e-book data file as discussed herein. Such a charge may differ based on whether an audio file is downloaded with a visual file, and/or what audio files are downloaded. For example, an upcharge may be made if the audio file is read by a famous musician (or, in the case of a thick client for audio presentation, if a local audible read at the e-book reader of the subject book by the famous person is enabled in the downloaded file. Further, an audible file may be downloadable in real time, and non-contemporaneously with a video reading file. For example, a visual reading file may be downloaded and, after a user has partially read a book associated with the visual reading file, the user may take a lengthy car trip and decide to download and use an audio file corresponded to the same book as was the visual file.

In any case, whether the audio and visual reading files are downloaded contemporaneously or not, the audio and video files are preferably synchronized once both are present at step 330. More particularly, the location within each file should be tracked by the microprocessor, such that an end location is saved at each time stamp during reading. Thereby, if the modality is switched, such as from visual read to audio read, or audio read to visual read, the user will pick up at the same, or substantially the same, location in the story, article, etc., whereat the user left off.

At step 340, the microprocessor may be instructed to assess the requested, or available, modalities of presenting the reading data files. For example, if a Bluetooth connection is available, the microprocessor may be instructed to provide an option to present an audio reading via the Bluetooth connect at step 350. At step 360, upon a change in available modalities, the microprocessor may be instructed to provide the option to switch modalities and, upon receipt of an instruction to switch, may obtain from the associated memory the most current reading location of the user prior to the switch, may locate substantially the same location from the memory in the new data file to which the switch is to be made, and may be instructed to begin the read in the new modality at that same location in the read.

Although the disclosure has been described and pictured in an exemplary form with a certain degree of particularity, it is understood that the present disclosure of the exemplary form has been made by way of example, and that numerous changes in the details of construction and combination and arrangement of parts and steps may be made without departing from the spirit and scope of the disclosure as set forth in the claims hereinafter.

What is claimed is:

1. An electronic book reader, comprising:
a display;
at least one microprocessor that visually executes one of a plurality of book data to said display;
at least one storage element that stores the plurality of book data; and
a plurality of modes executable by said at least one microprocessor, wherein at least one of said plurality of modes comprises an audible executing of the one of the plurality of book data to at least one Bluetooth output.

2. The electronic book reader of claim 1, wherein the Bluetooth output comprises a communicative connection to an earbud.

3. The electronic book reader of claim 1, wherein the Bluetooth output comprises a communicative connection to automobile speakers.

4. The electronic book reader of claim 1, wherein the one of the plurality of book data further comprises a story location indicated by said at least one storage element, and wherein the audible executing comprises a start at the story location.

5. The electronic book reader of claim 1, wherein said display comprises a tablet computer display.

6. The electronic book reader of claim 1, wherein said display comprises a dedicated e-book display.

7. The electronic book reader of claim 1, wherein said display comprises a smartphone display.

8. A method of executing an electronic book reading, comprising:
storing a plurality of electronic book data;
visually outputting the electronic book data to a display;
enabling a user to scroll through the book data on the display; and
audibly outputting the electronic book data, to at least one speaker via a Bluetooth interfacing, simultaneously with and synchronized to said visually outputting.

9. The method of claim 8, further comprising receiving, via at least one network, the plurality of electronic book data.

10. The method of claim 9, wherein the at least one network comprises a Wi-Fi network.

11. The method of claim 9, wherein the at least one network comprises one selected from a 3G and a 4G network.

12. The method of claim 9, further comprising uploading payment information to enable said storing.

13. The method of claim 9, further comprising synchronizing said audibly outputting and said visually outputting.

14. The method of claim 9, further comprising receiving a change in modality to enable said audibly outputting.

15. The method of claim 9, wherein the speaker comprises an automobile speaker.

16. The method of claim 9, wherein the speaker comprises an earbud.

17. The method of claim 16, further comprising charging the earbud via a housing physically associated with the Bluetooth interfacing.

18. A portable electronic device for at least alternately providing an audio reading output and a visual reading output for electronic book data, comprising:
a display;
at least one microprocessor suitable for visually executing the visual reading output of the electronic book data to said display;
at least one storage element locally electrically communicatively associated with said at least one microprocessor suitable for at least temporarily storing the electronic book data; and
a mode switch comprised of a plurality of computer-executable instructions locally executable by said at least one microprocessor and suitable for switching from the visual reading output to the audio reading output in accordance with at least one hardware input.

19. The electronic device of claim 18, wherein the hardware input comprises a Bluetooth indicator, and wherein the audio reading output comprises a Bluetooth audio output.

20. The electronic device of claim 18, wherein the hardware input comprises at least one of an insertion of headphones, and a user input to said display.
